(19) United States
(12) Patent Application Publication
(10) Pub. No.: US 2014/0374210 A1
(43) Pub. Date: Dec. 25, 2014

(54) POWERTRAIN MECHANISM FOR VEHICLES WITH INTERNAL COMBUSTION ENGINE

(71) Applicant: VALEO OTOMOTIV SISTEMLERI ENDÜSTRISI A.S., Osmangazi / BURSA PK (TR)

(72) Inventor: Serkan GÜRSES, Osmangazi / BURSA PK (TR)

(73) Assignee: VALEO OTOMOTIV SISTEMLERI ENDÜSTRISI A.S., Osmangazi / BURSA PK (TR)

(21) Appl. No.: 14/286,386

(22) Filed: May 23, 2014

(30) Foreign Application Priority Data
Jun. 20, 2013 (TR) 2013/07453

(51) Int. Cl. F16D 13/52

(52) U.S. Cl. CPC F16D 13/52
USPC 192/70.11

(57) ABSTRACT

A powertrain mechanism comprising a carrier plate facing the engine side, a fixation plate facing the gearbox side, a drive plate positioned between said plates and provided such that there is a partial rotation freedom with respect to these plates, for transferring the power, received from the engine, to the gearbox, in vehicles having at least internal combustion engine, characterized by comprising at least one third friction element seating onto at least one friction region provided on one of said plates after being positioned between the carrier plate or fixation plate and drive plate, at least one connection plate fixing said third friction element to the friction region in order to keep a distance between the third friction element and the opposite plate, and at least one drive leg placed into at least one drive housing provided on the opposite plate by extending from the third friction element towards the opposite plate.

### CROSS-REFERENCE TO RELATED APPLICATIONS AND CLAIM TO PRIORITY

This application claims priority to Turkish Patent Application No. 2013/07453 filed Jun. 20, 2013, the disclosure of which is incorporated herein by reference and to which priority is claimed.

### FIELD OF INVENTION

The present invention relates to a powertrain mechanism positioned between the crankshaft and gearbox shaft, in order to be used in vehicles with internal combustion engine.

### BACKGROUND OF THE INVENTION

In vehicles with internal combustion engine, powertrain mechanisms are utilized between the crankshaft and the gearbox shaft for transmitting the power, obtained in the engine, to the wheels. Said powertrain mechanisms are designed so as to transmit power and so as to damp the vibrations occurring.

Said powertrain mechanisms comprise a rotary drive plate between the carrier plate and the fixation plate positioned between the crankshaft and the gearbox shaft. Thus, during said rotation movement, friction occurs between the plates. The frictions, occurring between the plates, are used for absorbing the vibrations occurring in the engine. Accordingly, different friction characteristics are desired to be obtained depending on the different vibration characteristics occurring in different engines. Various friction elements are disposed between the plates for providing this. Said friction elements are pushed towards the plates by means of spring washer and similar items. In these embodiments, the vibrations, coming in the axial direction through the crankshaft, affect the hysteresis value. As can be seen in the application with reference number DE3732818, the tolerances of the spring washers and the intermediate pieces used affect the obtained hysteresis value directly. Thus, it becomes difficult to reach the desired hysteresis value because of the characteristic of the spring used and because of the piece tolerances.

As a result, because of all of the abovementioned problems, an improvement is required in the related technical field.

### SUMMARY OF THE INVENTION

The present invention relates to a powertrain mechanism for use in vehicles with internal combustion engine, for eliminating the above mentioned disadvantages and for bringing new advantages to the related technical field.

The main object of the present invention is to provide a powertrain mechanism which can damp vibrations with different characteristics formed in internal combustion engines.

Another object of the present invention is to provide a powertrain mechanism where the hysteresis value can be adjusted in a sensitive manner for different vibration characteristics.

In order to realize all of the above mentioned objects and the objects which are to be deducted from the detailed description below, the present invention is a powertrain mechanism comprising a carrier plate facing the engine side, a fixation plate facing the gearbox side, a drive plate positioned between said plates and provided such that there is a partial rotation freedom with respect to these plates, for transferring the engine torque, received from the engine, to the gearbox, in vehicles having at least internal combustion engine. Accordingly, said powertrain mechanism is characterized by comprising at least one third friction element seating onto at least one friction region provided on one of said plates after being positioned between the carrier plate or fixation plate and drive plate, at least one connection plate fixing said third friction element to the friction region in order to keep a distance between the third friction element and the opposite plate, and at least one drive leg placed into at least one drive housing provided on the opposite plate by extending from the third friction element towards the opposite plate. Thus, a hysteresis torque, which can be controlled in an independent manner, is obtained.

In a preferred embodiment of the subject matter invention, the third friction element is provided on the friction region provided on the carrier plate, and the drive leg, extending from the third friction element towards the drive plate, is disposed to the drive housing provided on the drive plate.

In another preferred embodiment of the subject matter invention, the third friction element is positioned between the connection plate and the carrier plate, and the connection plate is connected to the carrier plate in order to keep a distance between the connection plate and the drive plate.

In another preferred embodiment of the subject matter invention, the drive housing width is greater than the drive leg width.

In another preferred embodiment of the subject matter invention, at least one elastic washer is provided between said connection plate and the third friction element. Thus, a hysteresis torque is obtained which is not affected by the vibrations coming in axial direction from the crankshaft.

In another preferred embodiment of the subject matter invention, at least one connection flap is provided in convoluted form towards the friction region of the connection plate.

In another preferred embodiment of the subject matter invention, in order to provide connection of said connection flap to the friction region, at least one fastening element is provided to connect to at least one fixation opening provided in the vicinity of the friction region.

In another preferred embodiment of the subject matter invention, at least one first friction element is provided between the carrier plate and the drive plate.

In another preferred embodiment of the subject matter invention, in order to push said first friction element towards the drive plate, at least one spring washer is provided between the first friction element and the carrier plate.

In another preferred embodiment of the subject matter invention, in order to provide connection of the first friction element to the carrier plate, at least one assembly recess is provided on the carrier plate and at least one assembly tab is provided extending towards said assembly recess by passing through the spring washer on the side of the first friction element facing the carrier plate correspondingly.

In another preferred embodiment of the subject matter invention, at the center of the support plate, there is at least one second hub opening whereon the assembly recess is provided.

In another preferred embodiment of the subject matter invention, said second hub opening is provided on an emboss portion provided on the support plate.

In another preferred embodiment of the subject matter invention, at least one fixation plate is provided on the side of the drive plate facing the gearbox shaft, and at least one second friction element is provided between said fixation plate and the drive plate.

In another preferred embodiment of the subject matter invention, at least one housing is provided on the fixation plate and correspondingly, at least one tab is provided on the side of the second friction element facing the fixation plate.

### BRIEF DESCRIPTION OF THE FIGURES

FIG. 1 is a representative exploded view of the subject matter powertrain mechanism.

FIG. 2 is a representative view of the inertia plate and the drive plate belonging to the subject matter powertrain mechanism.

FIG. 3 is a representative view of the carrier plate and the support plate of the subject matter powertrain mechanism.

FIG. 4 is a representative isometric view of the subject matter powertrain mechanism.

FIG. 5 is a representative cross sectional view of the subject matter powertrain mechanism.

### DETAILED DESCRIPTION OF THE PREFERRED EMBODIMENT(S)

In this detailed description, a powertrain mechanism (1) for providing power transmission between the crankshaft and gearbox shaft for automatic hybrid vehicles is explained with references to examples without forming any restrictive effect in order to make the subject more understandable.

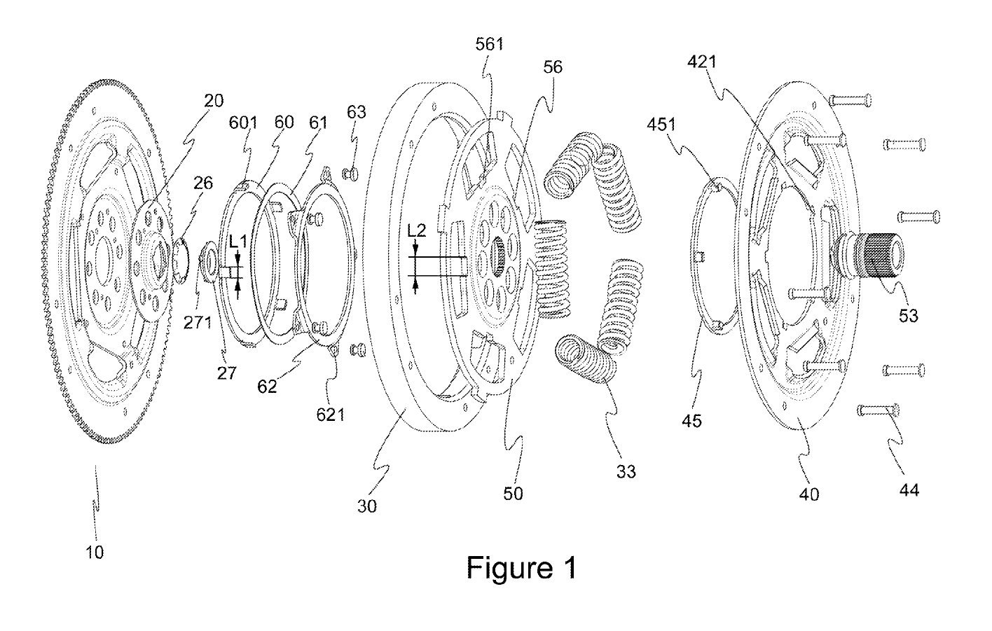

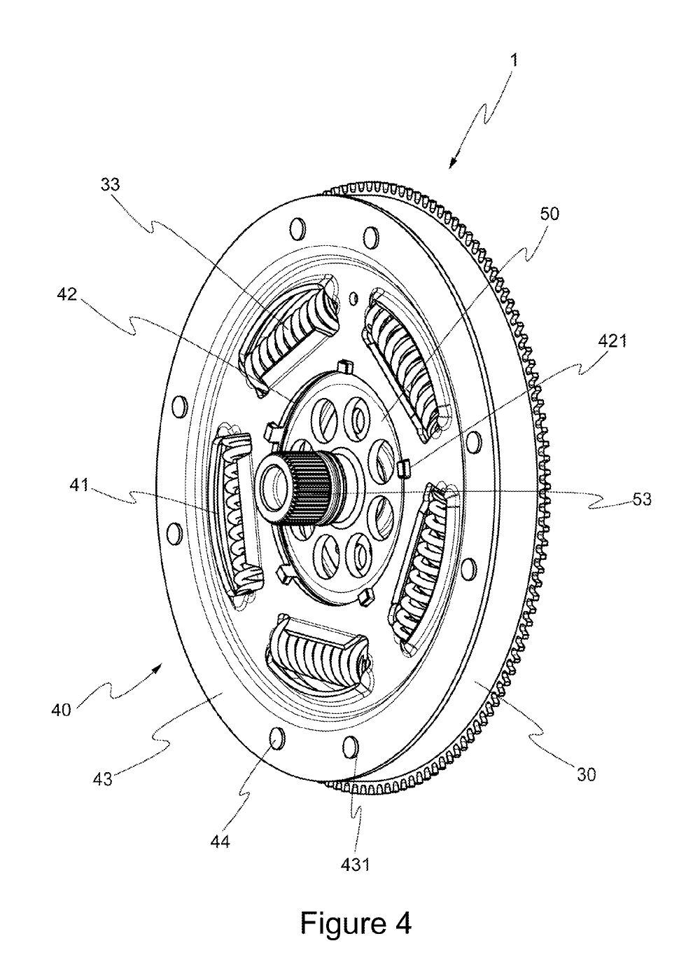

As can be seen in FIG. 1 and FIG. 4, the subject matter powertrain mechanism (1) comprises at least one carrier plate (10) facing the engine side in order to be connected to the crankshaft, at least one fixation plate (40) facing the gearbox side, at least one inertia plate (30) positioned between said carrier plate (10) and said fixation plate (40), and pluralities of springs (33).

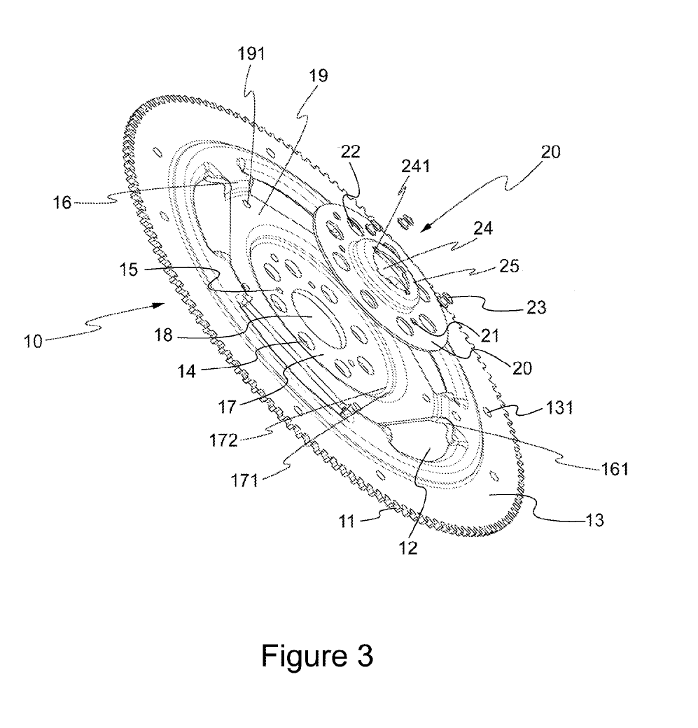

As can be seen in FIG. 3, the carrier plate (10) is provided in circular form. There is at least one first hub opening (18) provided in a circular hole form at the center of the carrier plate (10). Around said first hub opening (18), there are pluralities of first connection openings (14) provided in pluralities of circular holes form arranged at certain intervals on a circular axis and used for providing connection with the crankshaft. Moreover, during the connection of the crankshaft and the carrier plate (10), the end of the crankshaft is disposed to the first hub opening (18). An internal hub (17) is defined between the first hub opening (18) and a step (171) provided on the side of said first connection openings (14) facing the outer wall of the carrier plate (10). There are teeth (11) provided along the outer wall of the carrier plate (10). There is a first seating surface (13) provided in flat form with respect to the center from the wall where the teeth (11) are provided. There are pluralities of first assembly openings (131) arranged at certain intervals on a circular axis on said first seating surface (13). There are pluralities of first spring housings (12) arranged at certain intervals between the first seating surface (13) and the step (171). Said first spring housings (12) are provided in the form of openings wherein the springs (33) are disposed. There are support regions (16) at between first spring housings (12). Said support regions (16) have convoluted portions (161) provided so as to form an emboss towards the gearbox side. Springs (33) are positioned between said support regions (16), and said convoluted portions (161) prevent the removal of the springs (33) from their place.

Moreover, there is a friction region (19) remaining between the first spring housings (12) and the step (171). There is a third friction element (60) positioned on said friction region (19). Said third friction element (60) is provided in circle form. Moreover, there is at least one drive leg (601) provided in tab form on the inverse face of the third friction element (60) with respect to the carrier plate (10). In order to provide fixation of the third friction element (63), a connection plate (62) is positioned on the third friction element (60). Said connection plate (62) is provided in a circular form. The connection flaps (621), provided on the outer wall of the connection plate (62), are provided in convoluted form towards the carrier plate (10) so as to define a distance between the carrier plate (10) and the connection flaps (621). The connection of the connection plate (62) to the carrier plate (10) is realized by means of the fastening elements (63) through said connection flaps (621). Said fastening elements (63) are connected to the fixation openings (191) provided at the vicinity of the friction region (19). In an alternative embodiment of the present invention, the connection plate (62) is fixed by means of tabs extending from the connection plate (62) towards the carrier plate (10). Moreover, an elastic washer (61), provided between the third friction element (60) and the connection plate (62), presses the friction element (63) towards the carrier plate (10). In an alternative embodiment of the present invention, the elastic washer (61) can be positioned between the third friction element (60) and the carrier plate (10). Thus, the friction is provided between the third friction element (60) and the connection plate (62). In another alternative embodiment of the present invention, an additional washer is disposed between the third friction element (60) and the elastic washer (61), and thereby the friction amount can be changed.

The support plate (20), provided inside the powertrain mechanism (1), is essentially provided in circular form having a size equal to the internal hub (17) portion of the carrier plate (10). There is a second hub opening (24) at the center of said support plate (20). Said second hub opening (24) is provided on an emboss portion (25) provided on the side of the support plate (20) facing the fixation plate (40). Moreover, there is at least one assembly recess (241) provided on the inner wall of the second hub opening (24). Pluralities of assembly recesses (241) are provided at certain intervals. There are second connection openings (22) between said emboss portion (25) and the outer wall of the support plate (20). Said second connection openings (22) are positioned so as to match with the first connection openings (14) provided in the internal hub (17) of the carrier plate (10).

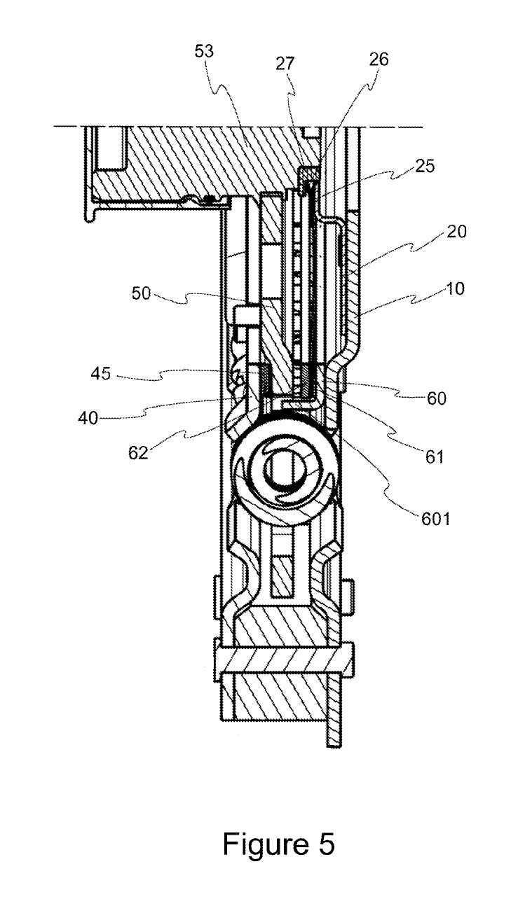

As can be seen in FIG. 5, the fixation plate (40) is provided in a form similar to the carrier plate (10). There are pluralities of fourth assembly openings (431) on the second seating surface (43) provided in the vicinity of the outer wall of the fixation plate (40). Said fourth assembly openings (431) match with the first assembly openings (131) provided on the carrier plate (10). Moreover, there is a third hub opening (42) provided at the center of the fixation plate (40). There is at least one housing (421) provided in recess form on the inner wall of said third hub opening (42). There are pluralities of second spring housings (41) between the third hub opening (42) and the second seating surface (43). Said second spring housings (41) are provided in equal size and form so as to correspond to the first spring housings (12) provided on the carrier plate (10).

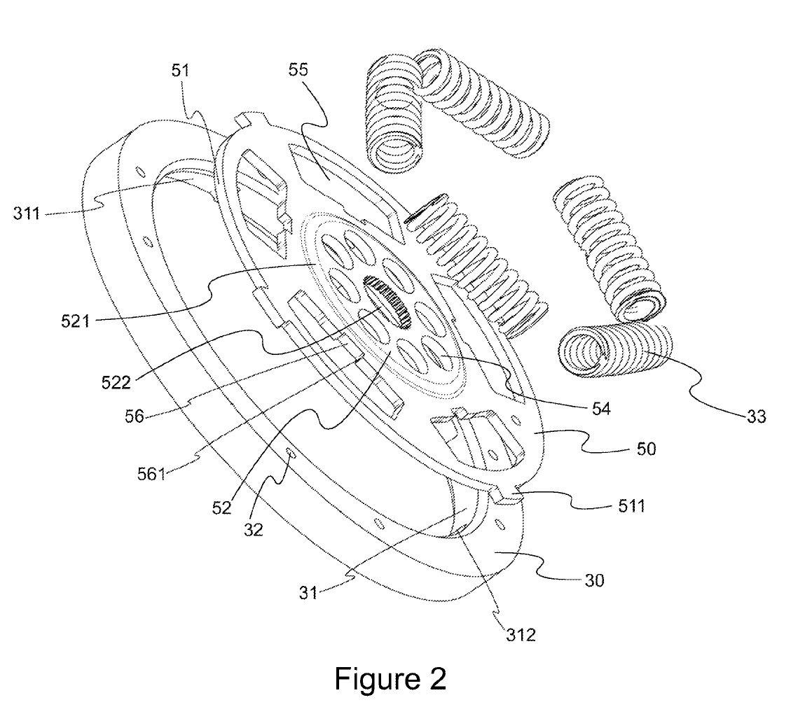

As can be seen in FIG. 2, the inertia plate (30), provided inside the powertrain mechanism (1), is in circular frame form. On the inner wall (31) of the inertia plate (30), pluralities of recesses (311) are provided such that there are certain distances in between. Said recesses (311) are provided at the intersection of the inner wall (31) and one face of the inertia plate (30). Moreover, in order to provide connection of the inertia plate (30) to the carrier plate (10) and to the fixation plate (40), there are pluralities of fifth assembly openings (32) extending between the two faces of the inertia plate (30) in a corresponding manner with respect to the first assembly opening (131) and the fourth assembly opening (431).

As can be seen in FIG. 2, the powertrain mechanism (1) comprises a drive plate (50) for transferring the movement received from the crankshaft to the gearbox shaft. The outer wall (51) of said drive plate (50) is provided in the form of a circular plate having a size so as to be placed into the inner wall (31) of the inertia plate (30). Moreover, at least one drive tab (511) is provided in a manner extending outwardly from the outer wall (51) of the drive plate (50). In the preferred application of the present invention, the number of drive tabs (511) provided is equal to the number of recesses (311) provided on the inertia plate (30). Since the width of the drive tabs (511) are embodied to be smaller than the width of the recesses (311), when the drive tabs (511) are positioned into the recesses (311), the drive plate (50) and the inertia plate (30) are provided to rotate in an independent manner of each other. At the center of the drive plate (50), there is a connection end opening (522) wherein a connection end (53) positioned for providing connection to the gearbox shaft. There is a hub (52) provided in emboss form in the middle portion of the face of the drive plate (50) facing the fixation plate (40). Said hub (52) is provided in a circular form. On the hub (52), there are pluralities of bolt passage openings (54) arranged on a circular axis around the connection end opening (522). Said bolt passage openings (54) are provided in a concentric manner with the first connection openings (14). Moreover, the diameters of the bolt passage openings (54) are embodied so as to be greater than the first connection openings (14) in a manner providing passage of bolts in an easier manner and in a manner providing passage of the fixtures which are to be used while bolts are being assembled when required. There are spring housings (55) positioned at certain intervals between the outer wall (51) of the drive plate (50) and the hub wall (521) formed at the outer periphery of the hub (52). Said spring housings (55) are provided in a corresponding manner with the first spring housings (12) provided on the carrier plate (10) and the second spring housings (41) provided on the fixation plate (40). There are drive housings (56) which are provided in recess form at the edge of the spring housings (55) close to the center of the drive plate (50). Said drive housings (56) are provided in a wider manner than the drive leg (601) provided on the third friction element (60). In other words, the drive housing width (L2) is greater than the drive leg width (L1).

The second assembly opening (15) provided in the internal hub (17) of the carrier plate (10) and the third assembly opening (21) provided on the support plate (20) are used for connecting the carrier plate (10) to the support plate (20). The second assembly openings (15) of the carrier plate (10) are kept in a concentric manner with the third assembly openings (21) of the support plate (20), and afterwards the pieces are fixed to each other by using the assembly elements (23). Moreover, meanwhile, the support plate (20) is seated to the step inner wall (172) of the step (171). By means of said fixation process, the carrier plate (10) and the support plate (20) are movable together. In the preferred application of the present invention, rivet is used as the assembly element (23). Moreover, the steps (not illustrated in the figures) formed in the second assembly opening (15) and in the third assembly opening (21), prevent formation of any tab on the surfaces of carrier plate (10) and of the support plate (20) due to use of assembly element (23) particularly by means of a rivet.

During the assembly of the powertrain mechanism (1), first of all, the support plate (20) is fixed to the carrier plate (10). Afterwards, the springs (33) are disposed inside of the first spring housings (12). During positioning of the drive plate (50) onto the carrier plate (10), a spring washer (26) and a first friction element (27) are positioned between the inertia plate (30) and the carrier plate (10). Said spring washer (26) has a hollow form and is made of metal material. Said first friction element (27) is preferably made of plastic material. Moreover, the first friction element (27) has assembly tabs (271) provided on the side thereof facing the carrier plate (10). The spring washer (26) is seated onto the emboss portion (25) provided in the middle region of the support plate (20) connected to the carrier plate (10). Afterwards, the first friction element (27) is seated on the spring washer (26) such that the assembly tabs (271) are disposed to the assembly recesses (241) provided on the support plate (20). In other words, the spring washer (26) is fixed between the first friction element (27) and the support plate (20). While the drive plate (50) is seated onto the first friction element (27), the springs (33) are disposed to the spring housings (55) provided on the drive plate (50). At the same time, the drive legs (601), which are provided on the third friction element (60), are disposed to the drive housings (56) provided on the drive plate (50). At the continuation thereof, the inertia plate (30) is disposed to the first seating surface (13). Meanwhile, the drive tabs (511) of the drive plate (50) are disposed into the recesses (311) provided on the inertia plate (30). The fixation plate (40) is disposed onto the inertia plate (30) such that the springs (33) are disposed on the second spring housings (41). Meanwhile, at least one second friction element (45) is positioned between the fixation plate (40) and the drive plate (50). One face of said second friction element (45) is seated onto the hub (52) of the drive plate (50). The tabs (451), provided on the face of the second friction element (45) facing the fixation plate (40), are disposed to the fixation housings (421) provided on the walls of the third hub opening (42) provided on the fixation plate (40). Thus, the second friction element (45) is fixed between the fixation plate (40) and the drive plate (50). At the same time, the contact of the fixation plate (40) to the drive plate (50) is prevented. Finally, after the fourth assembly openings (431) provided on the fixation plate (40) are positioned so as to be in the same direction as the first assembly openings (131) provided on the carrier plate (10), fixation process is realized by means of the connection elements (44) passing through the first assembly openings (131) and the fifth assembly openings (32) provided on the inertia plate (30). Depending on this connection type, the inertia plate (30) is positioned and fixed between the carrier plate (10) and the fixation plate (40). In the preferred application of the present invention, rivet is used as the connection element (44). Moreover, the assembly of the powertrain mechanism (1) and the crankshaft is realized by means of connection elements passed through the first connection opening (14) provided on the internal hub (17) and passed through the second connection opening (22) provided on the support plate (20) correspondingly. As a result, the structure whose isometric view is given in FIG. 4 and whose cross sectional view is given in FIG. 5 is obtained.

In the light of the all structural details described, during the operation of the subject matter powertrain mechanism (1), the frictions occurring within the period from the beginning of compression of the springs (33) until the contact of the drive tabs (511) to the stop points (312) are as follows. The carrier plate (10), connected to the crankshaft, transfers the movement received from the crankshaft to the inertia plate (30) and to the fixation plate (40) through the connection elements (44). Meanwhile, the rotation movement is transferred to the drive plate (50) by means of the springs (33). Thus, in the beginning of the movement, the springs (33) are compressed. Then the drive plate (50) and the other items rotate in different angular velocities, therefore frictions occur between them. Accordingly, the first friction element (27), provided on the support plate's (20) side which faces the drive plate (50), contacts the connection end (53) provided in the middle of the drive plate (50). Moreover, the first friction element (27) remains fixed without rotating thanks to the assembly tabs (271) providing connection to the support plate (20). On the other hand, the second friction element (45), provided on the side of the drive plate (50) facing the fixation plate (40), remains fixed without rotating thanks to the tabs (451) disposed to the housings (421) provided on the fixation plate (40). In said embodiment, the flexibility of the spring washer (26) provided between the first friction element (27) and the support plate (20) affects the hysteresis torque occurring in the first friction element (27) and the second friction element (45). In more details, the spring washer (26) pushes the first friction element (27) towards the drive plate (50) and thus, the drive plate (50) presses the second friction element (45) to the fixation plate (40). Thus, by means of using spring washers (26) with different characteristics, different hysteresis values can be reached. However, the tolerances of the items between the support plate (20) and the fixation plate (40) affect the hysteresis values with the characteristics of the spring washer (26). In more details, the dimensional tolerance of the emboss portion (25), fixation plate (40) and spring washer (26), the position of the drive plate (50) with respect to the connection end (53), and thickness of the drive plate (50) affect the friction values. On the other hand, the spring washer (26) provided between the first friction element (27) and the support plate (20) dampens the axial vibration which may be applied by the crankshaft.

During movement transfer in the subject matter powertrain mechanism (1), while the springs (33) are compressed, another region where hysteresis torque occurs is between the carrier plate (10) and the third friction element (60). In more details, when the drive plate (50) begins the first movement, the drive leg (601) provided on the third friction element (60) moves inside the drive housing (56) provided on the drive plate (50). Since the drive housing width (L2) is greater than the drive leg width (L1), no force is applied to the third friction element (60) as soon as the drive plate (50) begins movement. After the rotation of drive plate (50) at a predetermined angle, the lateral edge (561) of the drive housing (56) touches the drive leg (601) in consequence the third friction element (60) begins to rotate. In said embodiment, since the elastic washer (61) disposed between the third friction element (60) and the connection plate (62) is selected to have different characteristics, different hysteresis values can be obtained. Since the third friction element (60) is fixed to the carrier plate (10) by means of the connection plate (62), only the tolerances of the connection plate (62) affect the hysteresis value to be obtained. In other words, an independent hysteresis value is obtained which is not affected by the tolerances of the other pieces. Moreover, said hysteresis value remains in a stabile form.

According to an exemplary operation type of the subject matter powertrain mechanism (1), a hysteresis torque is formed by activating firstly the first friction element (27) and the second friction element (45) when a predetermined amount of torque is applied. At the continuation thereof, the third friction element (60) is activated after a rotation at a predetermined angle. The third friction element (60) is active until the compression of the springs (33) is ended. The compression amount in the springs (33) is determined depending on the amount of applied torque. When the compression of the springs (33) is completed, the third friction element (60) is deactivated, and only the first friction element (27) and the second friction element (45) are active until average torque amount changes. When the applied amount of torque is increased, the third friction element (60) is activated and it remains active until the compression of the springs (33) is ended. In a similar manner, when the applied torque amount is decreased or eliminated, the first friction element (27) and the second friction element (45) remain active for certain duration and afterwards, the third friction element (60) forms a friction in the inverse direction. In this case, the time duration passing for activating the third friction element (60) is equal to the duration in order for the drive leg (601) to complete the inverse movement thereof with respect to the first position inside the drive housing (56). At the continuation thereof, the third friction element (60) is deactivated again after certain duration.

As a result, by means of the provided embodiment, as the third friction element (60) is activated, higher vibration values can be dampened. Moreover, when the friction values obtained by means of the first friction element (27) and by means of the second friction element (45) are insufficient, the total friction value can be changed in a sensitive manner by using elastic washers (61) having different characteristics. In other words, since change of the elastic washer (61) does not change the hysteresis value obtained in the first friction element (27) and in the second friction element (45), the desired total hysteresis value can be reached easily. Moreover, an additional hysteresis is obtained against the vibrations formed in instant torque changes.

Besides, by means of said embodiment, the hysteresis torque obtained in the third friction element (60) is provided to be independent of the hysteresis torque formed by the other first friction element (27) and the second friction element (45). Accordingly, since the elastic washer (61) which is in interaction with the third friction element (60) does not affect the first friction element (27) and the second friction element (45), the hysteresis, obtained in the first friction element (27) and in the second friction element (45), can be kept at low values. Moreover, since the number of components interacted with the third friction element (60) is small, the effect of the size tolerances of the components on the hysteresis torque is weak.

In the alternative embodiment of the present invention, the third friction element (60) can be connected to the drive plate (50) in an inverse manner with respect to the present structure. In this case, movement is transferred to the third friction element (60) by means of the carrier plate (10). Thus, friction occurs between the drive plate (50) and the third friction element (60).

In another alternative embodiment of the present invention, the third friction element (60) can be positioned between the fixation plate (40) and the drive plate (50). Accordingly, the friction region (19) is provided on the fixation plate (40) or on the face of the drive plate (50) facing the fixation plate (40). Thus, in a similar manner to the above mentioned structure, hysteresis can be obtained between the third friction element (60) and the drive plate (50) or between the third friction element (60) and the fixation plate (40).

The protection scope of the present invention is set forth in the annexed Claims and cannot be restricted to the illustrative disclosures given above, under the detailed description. It is because a person skilled in the relevant art can obviously produce similar embodiments in the light of the foregoing disclosures, without departing from the main principles of the present invention.

1. A powertrain mechanism (1) comprising a carrier plate (10) facing the engine side, a fixation plate (40) facing the gearbox side, a drive plate (50) positioned between said plates (10, 40) and provided such that there is a partial rotation freedom with respect to these plates (10, 40), for transferring the power, received from the engine, to the gearbox, in vehicles having at least internal combustion engine, characterized by comprising at least one third friction element (60) seating onto at least one friction region (19) provided on one of said plates (10, 40, 50) after being positioned between the carrier plate (10) or fixation plate (40) and drive plate (50), at least one connection plate (62) fixing said third friction element (60) to the friction region (19) such in order to keep a distance between the third friction element (60) and the opposite plate (10, 40, 50), and at least one drive leg (601) placed into at least one drive housing (56) provided on the opposite plate (10, 40, 50) by extending from the third friction element (60) towards the opposite plate (10, 40, 50).

2. A powertrain mechanism (1) according to claim 1, characterized in that the third friction element (60) is provided on the friction region (19) provided on the carrier plate (10), and the drive leg (601), extending from the third friction element (60) towards the drive plate (50), is disposed to the drive housing (56) provided on the drive plate (50).

3. A powertrain mechanism (1) according to claim 2, characterized in that the third friction element (60) is positioned between the connection plate (62) and the carrier plate (10), and the connection plate (62) is connected to the carrier plate (10) in order to keep a distance between the connection plate (62) and the drive plate (50).

4. A powertrain mechanism (1) according to claim 1, characterized in that the drive housing width (L2) of the drive housing (56) is greater than the drive leg width (L1) of the drive leg (601).

5. A powertrain mechanism (1) according to, claim 1 characterized in that at least one elastic washer (61) is provided between said connection plate (62) and the third friction element (60).

6. A powertrain mechanism (1) according to claim 1, characterized in that at least one connection flap (621) is provided in convoluted form towards the friction region (19) of the connection plate (62).

7. A powertrain mechanism (1) according to claim 6, characterized in that in order to provide connection of said connection flap (621) to the friction region (19), at least one fastening element (63) is provided to connect to at least one fixation opening (191) provided in the vicinity of the friction region (19).

8. A powertrain mechanism (1) according to claim 1, characterized in that at least one first friction element (27) is provided between the carrier plate (10) and the drive plate (50).

9. A powertrain mechanism (1) according to claim 8, characterized in that in order to push said first friction element (27) towards the drive plate (50), at least one spring washer (26) is provided between the first friction element (27) and the carrier plate (10).

10. A powertrain mechanism (1) according to claim 9, characterized in that in order to provide connection of the first friction element (27) to the carrier plate (10), at least one assembly recess (241) is provided on the carrier plate (10) and at least one assembly tab (271) is provided extending towards said assembly recess (241) by passing through the spring washer (26) on the side of the first friction element (27) facing the carrier plate (10) correspondingly.

11. A powertrain mechanism (1) according to claim 10, characterized in that at the center of the support plate (20), there is at least one second hub opening (24) whereon the assembly recess (241) is provided.

12. A powertrain mechanism (1) according to claim 11, characterized in that said second hub opening (24) is provided on an emboss portion (25) provided on the support plate (20).

13. A powertrain mechanism (1) according to claim 1, characterized in that at least one fixation plate (40) is provided on the side of the drive plate facing the gearbox shaft, and at least one second friction element (45) is provided between said fixation plate (40) and the drive plate (50).

14. A powertrain mechanism (1) according to claim 13, characterized in that at least one housing (421) is provided on the fixation plate (40) and correspondingly, at least one tab (451) is provided on the side of the second friction element (45) facing the fixation plate (40).

15. A powertrain mechanism (1) according to, claim 2 characterized in that at least one elastic washer (61) is provided between said connection plate (62) and the third friction element (60).

16. A powertrain mechanism (1) according to, claim 3 characterized in that at least one elastic washer (61) is provided between said connection plate (62) and the third friction element (60).

17. A powertrain mechanism (1) according to claim 4 characterized in that at least one elastic washer (61) is provided between said connection plate (62) and the third friction element (60).
